(19) United States
(12) Patent Application Publication
(10) Pub. No.: US 2019/0375090 A1
(43) Pub. Date: Dec. 12, 2019

(54) JOINT FOR A SWING WRENCH

(71) Applicant: Yi-Min Li, Taichung City (TW)

(72) Inventor: Yi-Min Li, Taichung City (TW)

(21) Appl. No.: 16/001,745

(22) Filed: Jun. 6, 2018

(51) Int. Cl. B25G 1/06; B25B 23/00

(52) U.S. Cl. CPC B25G 1/063; B25B 13/481; B25B 23/0035; B25B 23/0028

(57) ABSTRACT

A swing wrench includes a handle and a joint. The handle includes a bore in a side. The joint includes a fork-shaped element, an axle and a fastener. The fork-shaped element includes a base and two lugs formed on the base. The axle is located between and rotationally connected to the lugs. The axle includes a transverse tunnel in a middle portion thereof and an axial hole in an end. The axial hole is in communication with the transverse tunnel. The handle is partially inserted in the transverse tunnel. The fastener includes a reduced end inserted in the bore of the handle through the axial hole of the axle.

### BACKGROUND OF INVENTION

### 1. Field of Invention

The present invention relates to a swing wrench and, more particularly, to a joint for a swing wrench.

### 2. Related Prior Art

A wrench is operable to tighten or loosen a threaded bolt or a nut for example. There are various wrenches such as ratchet wrenches, socket wrenches, open-end wrenches, box wrenches, monkey wrenches and swing wrenches. Swing wrenches are particular useful for an operation in a limited space.

Taiwanese Patent No. 450185 discloses a swing wrench that includes a handle 20, a threaded element 30 and a head 40. The handle 20 includes two lugs 21 at an end and a bore 24 near the lugs 21. The threaded element 30 includes a thread 32. The threaded element 30 is inserted in the bore 24. The head 40 includes teeth 43 at a reduced end. The reduced end of the head 40 is located between and pivotally connected to the lugs 21 by a threaded bolt 42. The thread 32 is engaged with some of the teeth 43. By rotating the threaded element 30, the head 40 is pivoted relative to the handle 20. However, the engagement of the thread 32 with only some of the teeth 43 is not enough to keep the head 40 in position relative to the handle 20. Moreover, the pivoting of the head 40 relative to the handle 20 by rotating the threaded element 30 is slow.

Taiwanese Patent No. 569860 discloses a swing wrench that includes a handle 1, a head 3, a latch 20, a spring 25 and a ball 35. The handle 1 includes two lugs 15, a gap 14, a bore 13 and an aperture 18. The gap 14 is located between the lugs 15. The bore 13 is located near the gap 14. The aperture 18 includes an end in communication with the gap 14 and another end in communication with the bore 13. The ball 35 includes a middle portion inserted in the aperture 18, a front portion inserted in the gap 14, and a rear end portion inserted in the bore 13. The spring 25 and the latch 20 are inserted in the bore 13 so that the latch 20 is biased by the spring 25. The latch 20 includes a broad portion 23 and a elatively narrow portion 24. The head 3 includes teeth 34 at a reduced end 32. The reduced end 32 of the head 3 is located between and pivotally connected to the lugs 15 by a threaded bolt 17. The front portion of the ball 35 is engaged with two of the teeth 34. The rear portion of the ball 35 can be engaged with the broad portion 23 of the latch 20 to keep the front portion of the ball 35 engaged with the teeth 34, thereby retaining the head 3 in position relative to the handle 1. The rear portion of the ball 35 can be located near the narrow portion 24 of the latch 20 to allow the front portion of the ball 35 to leave the teeth 34, thereby allowing the head 3 to swing relative to the handle 1. However, the engagement of the front portion of the ball 35 with only two of the teeth 34 is not enough to keep the head 3 in position relative to the handle 1.

Taiwanese Patent No. 1241940 discloses a swing wrench that includes a head 10, a handle 20, a teethed element 28, a spring 29 and a latch 26 or 32. The head 10 includes teeth 101 at a reduced end 11. The handle 20 includes two lugs 21 and 22 at an end and a bore 27 near the lugs 21 and 22. In an aspect, the handle 20 further includes another bore 25 in communication with the bore 27. In an alternative aspect, the handle 20 further includes another bore 31 in communication with the bore 27. The teethed element 28 includes teeth 281 at an end and a recess 282 in a side. The toothed element 28 and the spring 29 are inserted in the bore 27. The latch 26 includes a reduced portion 261. The reduced end 11 of the head 10 is located between and pivotally connected to the lugs 21 by a pin 24. The spring 29 elastically pushes the teeth 281 into engagement with some of the teeth 101. The latch 26 is inserted in the bore 25, or the latch 32 is inserted in the bore 31. The latch 26 or 32 can be inserted in the recess 282 to keep the toothed element 28 in position to keep the teeth 281 in engagement with the teeth 101 to retain the head 10 in position relative to the handle 20. However, the engagement of the teeth 281 with only some of the teeth 101 is not enough to keep the head 10 in position relative to the handle 20. Moreover, the latch 26 or 32 could easily be moved out of the recess 282 by mistake to allow the teeth 281 to leave the teeth 101, thereby allowing the head 10 to swing relative to the handle 20.

Taiwanese Patent No. 1242483 discloses a swing wrench that includes a joint 2 and a head 3. The head 3 includes a square bore 33 and four circular bores 34. Each of the circular bores 34 in a wall of the square bore 33. The joint 2 includes a fork-shaped element 21 and an insert 22. The fork-shaped element 21 includes two lugs 211 at an end. A rear portion of the insert 22 is located and pivotally connected to the lugs 211 by a pin 23. A front portion of the insert 23 includes a bore 221 to contain a spring 222 and a ball 223. The front portion of the insert 23 is inserted in the square bore 33. The spring 222 elastically pushes the ball 223 partially into a selected one of the circular bores 34, thereby connecting the head 3 to the joint 2. No device is used to keep the insert 22 in position relative to the fork-shaped element 21.

To overcome the foregoing problems, the applicant of the present application has invented a swing wrench for which CN 2912931, DE 202006007131, TW M300591 and U.S. Pat. No. 7,237,463 have been issued.

The present invention is therefore intended to obviate or at least alleviate the problems encountered in prior art.

### SUMMARY OF INVENTION

It is the primary objective of the present invention to provide a reliable swing wrench.

To achieve the foregoing objective, the swing wrench includes a handle and a joint. The handle includes a bore in a side. The joint includes a fork-shaped element, an axle and a fastener. The fork-shaped element includes a base and two lugs formed on the base. The axle is located between and rotationally connected to the lugs. The axle includes a transverse tunnel in a middle portion thereof and an axial hole in an end. The axial hole is in communication with the transverse tunnel. The handle is partially inserted in the transverse tunnel. The fastener includes a reduced end inserted in the bore of the handle through the axial hole of the axle.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a swing wrench according to the preferred embodiment of the present invention;

FIG. 2 is a perspective view of the swing wrench shown in FIG. 1;

FIG. 3 is a side view of the swing wrench shown in FIG. 1;

FIG. 4 is a cross-sectional view of the swing wrench taken along a line B-B shown in FIG. 3; and

FIG. 5 is a cross-sectional view of the swing wrench taken along a line A-A shown in FIG. 3.

### DETAILED DESCRIPTION OF PREFERRED EMBODIMENT

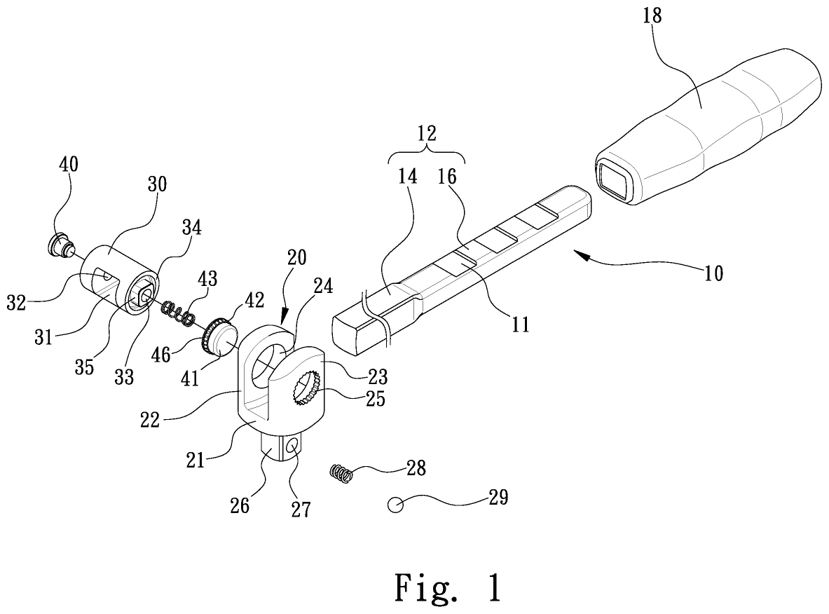

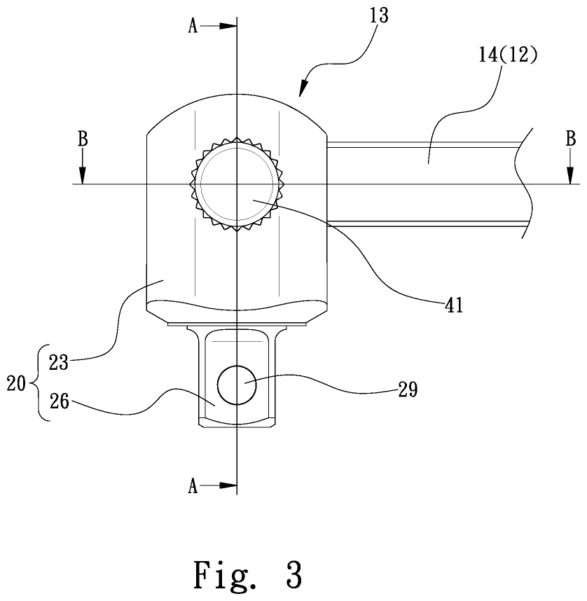

Referring to FIG. 1 through 5, a swing wrench 10 includes a handle 12, a joint 13 and a grip 18 according to the preferred embodiment of the present invention. For example, a socket (not shown) can be pivotally connected to the handle 12 via the joint 13. The socket can be engaged with a threaded bolt or a nut. Thus, the threaded bolt or nut can be rotated by the swing wrench 10.

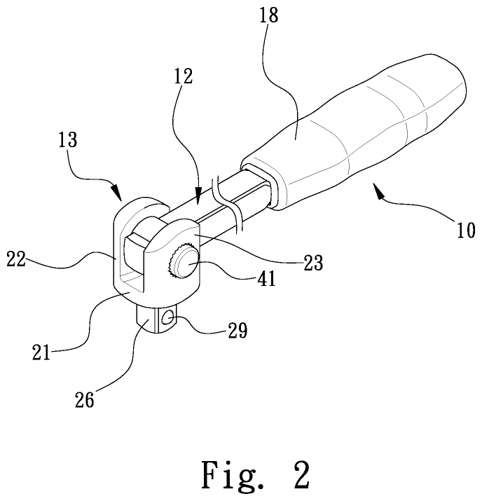

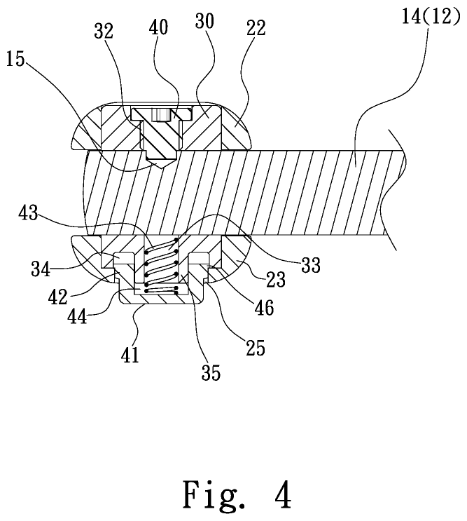

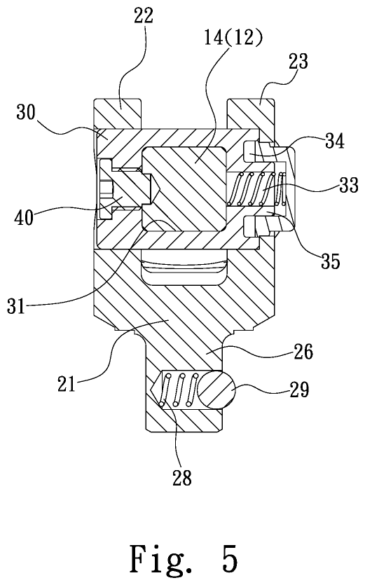

Referring to FIGS. 1 and 2, the handle 12 includes a front portion 14, a rear portion 16, and a bore 15 (FIG. 4) in a side of the front portion 14 thereof. The front portion 14 of the handle 12 is broader than the rear portion 16 of the handle 12. The front portion 14 of the handle 12 is substantially square (FIG. 5) in the preferred embodiment. However, the handle 12 can be in another non-circular shape in another embodiment. Preferably, the bore 15 is a screw bore.

The grip 18 includes bosses (not shown) on an internal face. The rear portion 16 of the handle 12 is inserted in the grip 18. The bosses of the grip 18 are inserted in the recesses 11 of the rear portion 16 of the handle 12 to keep the rear portion 16 of the handle 12 in the grip 18.

The rear portion 16 of the handle 12 includes several recesses 11 and the grip 18 includes several bosses in the preferred embodiment. However, the rear portion 16 of the handle 12 can include only one recess 11 and the grip 18 can includes only one boss in another embodiment.

Referring to FIGS. 1 and 2, the joint 13 includes a fork-shaped element 20, an axle 30, a fastener 40, a lock 41 and a spring 43. The fork-shaped element 20 includes a base 21, two lugs 22 and 23 formed on upper face of the base 21, and a square insert 26 extending from a lower face of the base 21. There is a gap (not numbered) between the lug 22 and the lug 23. The lug 22 includes an aperture 24. The lug 23 includes an aperture 24 and teeth 25 formed on the wall of the aperture 24. The square insert 26 is formed with a bore 27 to receive a spring 28 and a ball 29. The square insert 26 can be inserted in a square bore (not shown) in the socket, with the spring 28 pushing the ball 29 abutted against a wall of the square bore of the socket, thereby keeping the square insert 26 in the square bore of the socket.

The axle 30 includes a tunnel 31, a cavity 34 in a first end thereof, a non-circular protuberance 35 at the first end thereof, a bore 33 in the non-circular protuberance 35, and a countersink hole 32 in a second end thereof. An axis of the tunnel 31 extends perpendicular to an axis of the axle 30. The non-circular protuberance 35 is located in the cavity 34.

The lock 41 includes a button (not numbered) at a first end thereof, an annular flange 46 on the periphery thereof near a second end thereof, teeth 42 on the periphery thereof near the annular flange 46, and a non-circular bore 44 in the second end thereof. The diameter of the annular flange 46 is larger than that of a phantom circle defined by the tips of the teeth 42. The teeth 42 are shaped corresponding to the teeth 25.

The fastener 40 includes an enlarged end and a reduced end opposite to the enlarged end thereof. Preferably, the fastener 40 further includes a thread (not numbered) near the reduced end thereof.

Referring to FIG. 4, the spring 43 is inserted in the bore 33. The non-circular protuberance 35 is inserted in the non-circular bore 44. The spring 43 tends to push the lock 41 from the non-circular protuberance 35.

The first end of the axle 30 is inserted in the aperture 24 of the lug 23. The first end of the axle 30 is located against the teeth 25 and hence kept in the aperture 24 of the lug 23. The non-circular protuberance 35 is movably inserted in the non-circular bore 44. The annular flange 46 of the lock 41 is movably inserted in the cavity 34. The second end of the axle 30 is inserted in the aperture 24 of the lug 22.

The annular flange 46 of the lock 41 is located against the teeth 25 and hence kept in the aperture 24 of the lug 23. The front portion 14 of the handle 12 is inserted in the tunnel 31. The non-circular periphery of the front portion 14 of the handle 12 is in contact with the non-circular wall of the tunnel 31 to prevent the handle 12 from rotation relative to the axle 30, without inferring with the pivoting of the fork-shaped element 20 about the axle 30.

The fastener 40 is inserted in the countersink hole 32. The reduced end of the fastener 40 is inserted in the bore 15 of the handle 12. The thread of the fastener 40 is inserted in the bore 15, which is a screw bore so that the front portion 14 of the handle 12 keeping in the tunnel 31 and that the axle 30 is kept on the fork-shaped element.

Referring to FIG. 5, all of the teeth 42 are engaged with all of the teeth 25 so that the lock 41 is retained in position relative to the lug 23 of the fork-shaped element 20. The non-circular protuberance 35 is inserted in the non-circular bore 44 so that the axle 30 is kept in position relative to the lock 41. Thus, the handle 12 is kept in position relative to the fork-shaped element 20.

Advantageously, the engagement of all of the teeth 42 with all of the teeth 25 is enough to keep the lock 41 in position relative to the lug 23 of the fork-shaped element 20. The contact of the periphery of the non-circular protuberance 35 with the wall of the non-circular bore 44 is enough to retain the axle 30 in position relative to the lock 41. Hence, the handle 12 is firmly kept in position relative to the fork-shaped element 20.

To pivot the fork-shaped element 20 relative to the handle 12, the button of the lock 41 is pressed to move the lock 41 toward the axle 30, i.e., deeper into the cavity 34. Thus, the teeth 42 are disengaged from the teeth 25 to allow the lock 41 to rotate relative to the lug 23. Thus, the axle 30 is allowed to rotate relative to the lock 41. Hence, the handle 12 is allowed to rotate relative to the fork-shaped element 20.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A swing wrench comprising:
a handle (12) comprising a bore (15) in a side; and
a joint comprising:
a fork-shaped element (20) comprising a base (21), a primary lug (23) formed on the base (21), and a secondary lug (22) formed on the base (21); and
an axle (30) located between and rotationally connected to the lugs (22, 23), wherein the axle (30) comprising a transverse tunnel (31) in a middle portion thereof and an axial hole (32) in an end thereof and in communication with the transverse tunnel (31), wherein the handle (12) is partially inserted in the transverse tunnel (31); and
a fastener (40) comprising a reduced end inserted in the bore (15) of the handle (12) through the axial hole (32) of the axle (30).

2. The swing wrench according to claim 1, wherein the handle (12) further comprises a front portion (14) inserted in the transverse tunnel (31) so that the handle (12) is not rotated relative to the axle (30).

3. The swing wrench according to claim 2, wherein the front portion (14) of the handle (12) comprises a non-circular profile and the transverse tunnel (31) of the axle (30) is non-circular.

4. The swing wrench according to claim 1, wherein the joint further comprises a lock (41) movable between a locking position for keeping the axle (30) in position relative to the fork-shaped element (20) and a releasing position for allowing the axle (30) to rotate relative to the fork-shaped element (20).

5. The swing wrench according to claim 4, wherein the lock (41) is connected to the axle (30) so that they are not rotatable relative to each other.

6. The swing wrench according to claim 5, wherein the lock (41) comprises a non-circular bore (44) in an end thereof, wherein the axle (30) further comprises a non-circular protuberance (35) inserted in the non-circular bore (44) of the lock (41).

7. The swing wrench according to claim 4, wherein the lock (41) comprises teeth (42) thereon a periphery thereof, wherein the primary lug (23) comprises teeth (25) engaged with the teeth (42) of the lock (41) when the lock (41) is in the locking position.

8. The swing wrench according to claim 7, wherein the teeth (42) of the lock (41) are formed on a periphery of the lock (41), wherein the primary lug (23) comprises an aperture (24), wherein the teeth (25) of the primary lug (23) are formed on a wall of the aperture (24) of the primary lug (23).

9. The swing wrench according to claim 8, wherein the lock (41) comprises an annular flange (46) located against the teeth (25) of the primary lug (23) to keep the lock (41) on the primary lug (23).

10. The swing wrench according to claim 8, wherein the axle (30) is partially inserted in the aperture (24) of the primary lug (23).

11. The swing wrench according to claim 9, wherein the secondary lug (22) comprises an aperture (24) for receiving a portion of the axle (30).

12. The swing wrench according to claim 6, wherein the joint (13) further comprises a spring (43) compressed between the non-circular protuberance (35) and the lock (41), thereby biasing the lock (41) to the locking position.

13. The swing wrench according to claim 12, wherein the non-circular protuberance (35) comprises a bore (33) for receiving the spring (43).

14. The swing wrench according to claim 1, wherein the fork-shaped element (20) further comprises a non-circular insert (26) for insertion in a non-circular bore in a socket.

15. The swing wrench according to claim 1, wherein the fastener (40) comprises an enlarged end, wherein the axial hole (32) of the axle (30) is a countersink hole for receiving the fastener (40) so that the enlarged end of the fastener (40) is flush with the axle (30).
